(19) United States
(12) Patent Application Publication
(10) Pub. No.: US 2025/0260999 A1
(43) Pub. Date: Aug. 14, 2025

(54) METHOD AND DEVICE FOR THE AUTOMATIC REDEPLOYMENT OF THE GEOGRAPHICAL COVERAGE OF A WIRELESS TELECOMMUNICATIONS NETWORK

(71) Applicant: COMMISSARIAT A L’ENERGIE ATOMIQUE ET AUX ENERGIES ALTERNATIVES, PARIS (FR)

(72) Inventors: Christophe JANNETEAU, GIF-SUR-YVETTE (FR); Alexis OLIVEREAU, GIF-SUR-YVETTE (FR)

(21) Appl. No.: 18/996,393

(22) PCT Filed: Jul. 21, 2023
(86) PCT No.: PCT/EP2023/070278

§ 371 Date: Jan. 17, 2025

(30) Foreign Application Priority Data
Jul. 22, 2022 (FR) 2207559

(51) Int. Cl. H04W 16/18; H04L 41/40; H04L 43/0811; H04W 84/00

(52) U.S. Cl. CPC H04W 16/18; H04L 41/40; H04L 43/0811; H04W 84/005

(57) ABSTRACT

A device and a method automatically redeploys the geographical coverage of a wireless telecommunications network interconnecting a plurality of wireless mobile devices and a common back base. The method includes: partitioning an initial geographical coverage area of a wireless telecommunications network into sub-areas; assigning a mobile vehicle equipped with a wireless base station to each sub-area, with each mobile vehicle equipped with a wireless base station being connected to the back base via a wireless link, and being positioned in a geographical position offering wireless network coverage over the sub-area to a set of wireless mobile devices; monitoring the tethering of each wireless mobile device to at least one wireless base station of the initial geographical coverage area; determining whether a wireless mobile device is no longer tethered to any wireless base station of the initial geographical coverage area; determining, if the wireless mobile device is no longer tethered to any wireless base station, a geographical position for a mobile vehicle equipped with a wireless base station as a function of the geographical position of the untethered wireless mobile device, with the geographical position allowing wireless network connectivity to be established between the untethered wireless mobile device and the back base; and deploying a mobile vehicle equipped with a wireless base station to the geographical position, with the position defining a new geographical coverage sub-area corresponding to an extension of the initial geographical coverage area.

### CROSS-REFERENCE TO RELATED APPLICATIONS

This application is a National Stage of International patent application PCT/EP2023/070278, filed on Jul. 21, 2023, which claims priority to foreign French patent application No. FR 2207559, filed on Jul. 22, 2022, the disclosures of which are incorporated by reference in their entireties.

### FIELD OF THE INVENTION

The invention is in the technical field of telecommunications networks, and more specifically relates to a method for automatically redeploying the geographical coverage of a wireless telecommunications network interconnecting a set of wireless mobile devices and a back base.

### BACKGROUND

The technical problem addressed by the present invention is that of the loss or degradation of the quality of wireless connectivity between a set of wireless mobile devices (EM) and a back base (BA) during the geographical movement of these EMs over time. Indeed, with each of these EMs geographically moving over time, some can exit the wireless coverage area offered by the network as initially deployed, thereby losing the connectivity with the BA.

Furthermore, following these movements, the local density of the EMs can also vary over time, and can trigger an overload of some parts of the wireless network, and therefore a potential degradation of the quality of service (Qos) for some EMs, or, on the contrary, can show geographical areas covered by the wireless network while no EM is present in this area, thus making the coverage of the network unsuitable with respect to the requirements of the EMs.

Solutions exist for approaching this problem, such as that proposed in the patent application by the Applicant, published under number FR3117727 and entitled “Method and device for automatically deploying a communications network”. A method for automatically deploying a communications network is presented with a view to maintaining the wireless connectivity between a moving mission vehicle (VM), whether it is controlled by a person or is remotely-controlled or moves autonomously, and a back base (BA). The method relies on a set of Autonomous Robotic Communication Relays (RCRA) able to autonomously move along the trajectory followed by the VM and able to form a linear mesh/multi-hop wireless communications network between the VM and the back base (along the trajectory of the VM). The method allows the positioning of each RCRA to be automatically controlled along the trajectory of the VM, and allows a new RCRA to be added, if necessary, so as to preserve the wireless connectivity between the VM and the BA, and to ensure that the quality thereof is sufficient for two-way routing of the required data (by the mission of the VM) between the VM and the BA, despite the movement of the VM. This method allows the VM to remain connected to the BA, even in the event of a loss of direct wireless connectivity between the VM and the BA (for example at the coverage limit of the radio signal), via the automatic deployment of the RCRAs in order to preserve this connectivity. By virtue of this method, the VM can cover greater distances or enter more hostile environments (for example environments that are highly metallic and constrain the propagation of the radio signal) while maintaining quality connectivity with the BA. This method also includes a fallback mode that allows, when the VM turns around along its initial trajectory, automatic fallback of the RCRAs along said trajectory and progressive dismantling of the mesh/multi-hop network formed by the RCRAs by removing the RCRAs from the mesh network as soon as they are no longer necessary for maintaining the quality connectivity between the VM and the BA.

However, this solution does not allow the problem addressed by the present invention to be directly resolved since it only allows connectivity to be maintained with the back base for a single mobile vehicle and not for a set of mobile devices.

Thus, attempting to address the problem stated by the present invention by only using the method described in this patent application would then require considering each mobile device (EM) to be a VM and therefore associating each of the EMs with a set of RCRAs aimed at maintaining the connectivity between said EM and the BA. However, this approach would have a significant disadvantage, namely the requirement for a very large number of RCRAs in order to be able to serve a large enough fleet of mobile devices (EM).

Furthermore, a requirement exists for a solution that overcomes the disadvantages of the known approaches and that allows quality wireless connectivity to be maintained between a back base and each of the devices of a set of wireless devices.

### SUMMARY OF THE INVENTION

The present invention addresses this requirement by proposing a solution for automatically redeploying the geographical coverage of a wireless telecommunications network serving a set of mobile devices connected to a back base.

An aim of the present invention is a method for automatically redeploying the geographical coverage of a wireless telecommunications network interconnecting a set of wireless mobile devices (EM) and a back base (BA).

Advantageously, the method of the invention allows automatic redeployment (i.e., without human intervention) of the geographical coverage of a wireless telecommunications network, with a view to maintaining quality connectivity between each of the mobile devices and a back base at each instant, despite the geographical movement of these mobile devices over time.

The method of the invention also allows quality connectivity to be maintained between the various mobile devices of the same set, despite their movements, by routing the communications via the back base.

The method of the invention also allows, despite the movements of the mobile devices, quality connectivity to be maintained between each of the mobile devices of the same set and a back network, i.e., a third-party network connected to a back base, by routing the communications via the back base.

The solution relies on an innovative network architecture made up of a set of mobile vehicles equipped with a wireless base station (VMSSF) responsible for providing the wireless network coverage for the various mobile devices (EM), with each of the VMSSFs being connected to the BA via a wireless link, either directly or through one or more wireless mobile relays, with these relays being able to move autonomously in order to maintain the connectivity between a VMSSF and the BA at each instant.

In order to achieve the desired result, the method of the invention relies on a set of mobile vehicles each equipped with a wireless base station and denoted (VMSSF), with each mobile vehicle of this type being responsible for providing wireless network coverage for a set of mobile devices, with each of the VMSSFs being connected to a common back base via a wireless link, either directly, or through one or more wireless mobile relays (RCRA).

In one embodiment, the relays RCRA are able to move autonomously in order to maintain the connectivity between a mobile vehicle VMSSF and the back base at each instant, according to a method described in the aforementioned patent application.

The method of the present invention can be used for automatically determining whether the deployment of a VMSSF is required in a given area, for defining the position where this VMSSF deploys and for managing the automatic deployment of the VMSSF to this position in order to offer the wireless network connectivity in this area or to improve the connectivity in this area.

Advantageously, the method of the invention also can be used for automatically determining that a VMSSF is no longer useful in a given area and consequently for managing its repatriation to the back base for a possible future redeployment to another geographical area.

In the particular case where the system no longer has enough available VMSSFs (or no longer enough wireless mobile relays available for deploying a VMSSF in a given area), the method also allows a possible repatriation of an already deployed VMSSF to be triggered, thus freeing-up new resources, to allow the deployment of a VMSSF in a new targeted area.

In one embodiment, the invention implements a method relying on the use of a single mobile back base in order to maintain the connectivity of the wireless network between the mobile devices and the back network, despite the mobile devices moving over long distances.

In an alternative embodiment, the invention implements a method relying on the use of two mobile back bases in order to maintain the connectivity of the wireless network between the mobile devices and the back network, despite the mobile devices moving over long distances.

The invention has many industrial fields of application. The invention is applicable in all scenarios where wireless network coverage must be provided for a set of mobile devices moving in an environment, potentially over long distances, and where a fixed communication infrastructure that can be used by the mobile devices does not exist.

The invention addresses this requirement by allowing the automatic deployment (without human intervention) of temporary network coverage in the environment where the mobile devices are moving, with this network coverage itself being self-reconfigurable in order to offer the network connectivity required by the mobile devices at each instant, while minimizing the necessary resources. The network coverage thus provided by the solution therefore includes the feature of being mobile itself, and having variable coverage/extension/geometry.

By way of non-limiting examples, some scenarios where the use of the present invention is advantageous, are:

Emergency missions: to provide network coverage in a disaster area (earthquake, fire, flooding, etc.) that is potentially very wide and devoid of a pre-existing communications infrastructure, in order to allow different mobile participants (personnel, vehicles, robots, etc.) to carry out their mission (search for victims, etc.) by virtue of this temporary wireless network with self-reconfigurable coverage.

Security missions: such as monitoring an area (border, etc.) by means of a group of mobile participants.

Industrial missions: such as, for example, providing temporary wireless network coverage and self-reconfigurable coverage on a worksite (by definition constantly evolving) or for dismantling a critical installation (nuclear site).

In order to obtain the intended results, a method is proposed for automatically redeploying the geographical coverage of a wireless telecommunications network interconnecting a plurality of wireless mobile devices and a common back base, the method comprising the following steps of:
partitioning the geographical coverage area of the wireless telecommunications network into sub-areas;
assigning a mobile vehicle equipped with a wireless base station to each sub-area, with each mobile vehicle equipped with a wireless base station being connected to said back base via a wireless link, and being positioned in a geographical position offering wireless network coverage over said sub-area to a set of wireless mobile devices;
determining the loss or the degradation of the quality of the wireless network connectivity between a set of wireless mobile devices and the back base;
determining a new geographical position for a mobile vehicle equipped with a wireless base station allowing the wireless network connectivity between said set of wireless mobile devices and the back base to be offered or improved; and
deploying a mobile vehicle equipped with a wireless base station to said position.

The method can operate according to alternative or combined embodiments.

In one embodiment, the step of determining the loss or the degradation of the quality of the wireless network connectivity between a set of wireless mobile devices and the back base comprises steps involving continuously monitoring (a) the tethering of the wireless mobile devices of each set of mobile devices to the mobile vehicle equipped with a wireless base station to which the set is linked, (b) the location of each of the mobile devices, and (c) the risk of overloading the wireless cells of the mobile vehicles equipped with a wireless base station.

In one embodiment, the step of monitoring the parameter (a) of tethering the mobile devices involves detecting when a mobile device is no longer under the wireless network coverage of any deployed mobile vehicle equipped with a wireless base station, and reconfiguring the wireless network.

In one embodiment, the step of reconfiguring the wireless network comprises the following steps of:
determining the last known location of the mobile device disconnected from the wireless network;
defining a new geographical sub-area in the vicinity of the last known location of said mobile device;
checking that at least one mobile vehicle equipped with a wireless base station is still available for serving said new sub-area; and
deploying said at least one mobile vehicle equipped with an available wireless base station to said new sub-area.

In one embodiment, the step of monitoring the parameter (a) of tethering the mobile devices involves detecting when a mobile vehicle equipped with a wireless base station is unused, and reconfiguring the wireless network.

In one embodiment, the step of reconfiguring the wireless network comprises the following steps of:
determining that no mobile device is connected to the mobile vehicle equipped with a wireless base station that is detected as being unused;
deactivating the wireless cell of said mobile vehicle equipped with a wireless base station and resetting the parameters of said wireless cell; and
repatriating the mobile vehicle equipped with a wireless base station to a storage area.

In one embodiment, the step of monitoring the parameter (c) of the risk of overloading wireless cells involves determining the location of the mobile vehicle equipped with a wireless base station that has issued an overload risk notification, and reconfiguring the wireless network.

In one embodiment, the step of reconfiguring the wireless network comprises the following steps of:
defining a geographical position in the vicinity of the location of the mobile vehicle equipped with a wireless base station that has issued an overload risk notification in order to deploy a new mobile vehicle equipped with a wireless base station;
checking that at least one mobile vehicle equipped with a wireless base station is still available and undeployed;
defining the parameters of the wireless cell of said new mobile vehicle equipped with a wireless base station;
deploying said new mobile vehicle equipped with a wireless base station to the defined geographical position;
activating the additional coverage of the wireless network offered by said new mobile vehicle equipped with a deployed wireless base station.

The method can further comprise steps involving determining that a mobile vehicle equipped with a wireless base station is no longer useful in a given area and repatriating it to the back base.

The method can further comprise steps involving determining a new geographical position for the back base and moving said back base to the new geographical position.

The method can further comprise steps involving determining a geographical position for a second back base, moving said second back base to the geographical position, and deploying a new wireless network interconnecting the plurality of wireless mobile devices and said second back base.

The invention also relates to a device comprising means for implementing the steps of the method of the invention.

According to alternative embodiments of the device of the invention, the mobile vehicle equipped with a wireless base station is a land or air or amphibious or aquatic vehicle, with said vehicle being remote-controlled or self-controlled (without human intervention).

In an advantageous embodiment, the wireless communication network is implemented according to an SDN “Software Defined Networking” oriented architecture comprising an SDN controller having a Northbound Interface and a Southbound Interface, set up in a central system (in a back base or a server connected to the back network). The SDN controller is able to control the configurations of SDN devices formed by the one or more back bases, the one or more mobile vehicles and the set of relays via its Southbound Interface, and is able to implement the steps of the method of the invention in the form of an SDN Service via its Northbound Interface.

The invention also relates to a computer program product that comprises code instructions for carrying out the steps of the method of the invention when the program is executed on a computer.

### BRIEF DESCRIPTION OF THE DRAWINGS

Further features and advantages of the invention will become apparent from the following description and from the figures in the appended drawings, in which:

FIG. 1 illustrates an application environment for the invention, implementing a plurality of mobile vehicles equipped with a wireless base station (VMSSF) connected to a back base (BA), offering wireless network coverage to a plurality of wireless mobile devices (EM);

FIG. 2 is a flowchart of the steps carried out for an initial deployment of a wireless network within the context of the invention;

FIG. 3 is a flowchart of the general steps carried out to trigger the automatic redeployment of the wireless network within the context of the invention;

FIG. 4 is a flowchart of the steps carried out to trigger the automatic redeployment of the wireless network in one embodiment;

FIG. 5 is a flowchart of the steps carried out to trigger the automatic redeployment of the wireless network in one embodiment;

FIG. 6 is a flowchart of the steps carried out to trigger the automatic redeployment of the wireless network in one embodiment;

FIG. 7 is a flowchart of the steps carried out by the method of the invention in an embodiment with movement of a back base;

FIG. 8 is a flowchart of the steps carried out by the method of the invention in another embodiment with movement of two back bases; and

FIG. 9a to FIG. 9i illustrate various embodiments of the method of the invention.

### DETAILED DESCRIPTION

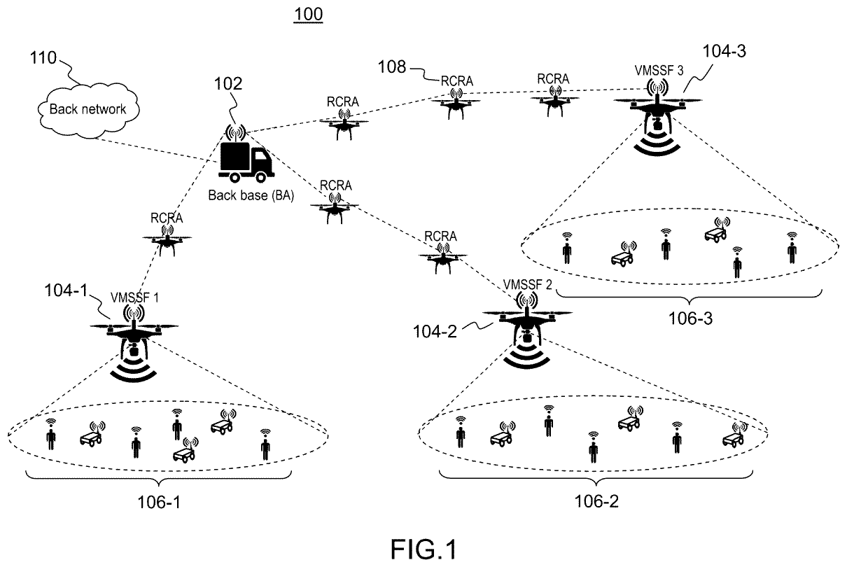

FIG. 1 illustrates an environment 100 for implementing the invention, in the example of three mobile vehicles equipped with a wireless base station (VMSSF: 104-1, 104-2, 104-3) connected to the same back base (BA: 102), either directly or via autonomous robotic communication relays (RCRA: 108). Each mobile vehicle equipped with a wireless base station (VMSSF) that offers wireless network coverage to a plurality or a set of wireless mobile devices (EM: 106-1, 106-2, 106-3).

Within the context of the invention, a mobile vehicle equipped with a wireless base station (VMSSF) is characterized by the following elements:

A VMSSF is a vehicle that is automatically remotely-controlled (i.e., without human intervention) from the back base (BA), or from a server located in a back network 110 connected to the BA. The VMSSF thus can be automatically repositioned to a given geographical point, for example, by indicating the geographical coordinates of this targeted point or even by indicating a trajectory to be followed.

A VMSSF is equipped with a wireless base station allowing it to provide wireless network connectivity in a geographical area in the vicinity of its location. Any type of wireless transmission technology can be used for this wireless network coverage offered by the VMSSF, such as, for example, radio transmissions in any type of RF band (Wi-Fi, 4G, 5G, etc.), transmissions over the visible part of the electromagnetic spectrum (for example Li-Fi transmissions) or even acoustic transmissions (underwater).

In one embodiment, a VMSSF (as well as the back base) can be configured to implement a method for establishing and maintaining a quality wireless link between the BA and the VMSSF when direct wireless connectivity between the two can no longer be ensured. This method, which can be, for example, a method according to that described in the aforementioned patent application of the Applicant, then allows the connectivity between the VMSSF and the BA to be maintained through one or more wireless mobile relays (RCRA) able to autonomously move along the trajectory of the VMSSF. Here again, any type of wireless transmission technology can be used between the VMSSF and the BA, such as, for example, radio transmissions in any type of RF band (for example an ad-hoc Wi-Fi transmission), transmissions over the visible part of the electromagnetic spectrum (for example Li-Fi transmissions) or even acoustic transmissions (for example underwater). Within the scope of the present invention, the implementation of such a method remains optional in the sense that it is not necessary as long as the VMSSF and the BA remain connected to each other via a direct wireless connection offering a sufficient range for covering their relative distances.

Within the context of the invention, a back base (BA) can assume various forms, such as, for example:
a server on the Internet or a platform in the cloud;
a server deployed on an intervention site;
a fixed or mobile server, for example, deployed in any type of vehicle (for example a truck).

The BA can be connected to a back network via any type of transmission technologies (for example via a satellite link).

The BA is typically associated with a “storage area” that can accommodate a set of VMSSFs with a view to their future deployment in the field for deploying the wireless network. By way of example, the BA can be positioned on a truck (as illustrated in FIG. 1) and the storage area can be a platform/trailer associated with the truck. When the VMSSFs are stored in the storage area, the wireless cells associated with these VMSSFs are deactivated. In one embodiment, the same storage area can accommodate the VMSSFs and the RCRAs.

Thus, the present invention can be implemented with variants of these configurations and can be applied to multiple scenarios defined by new missions.

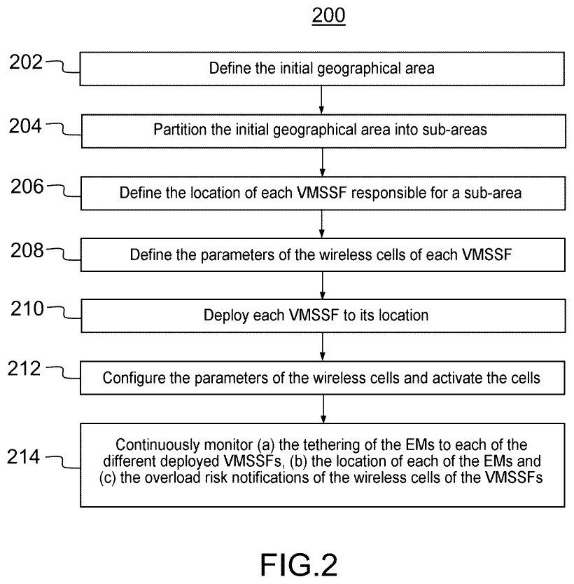

FIG. 2 is a flowchart of the steps 200 carried out for an initial deployment of a wireless communication network within the context of the invention. The wireless network is deployed with a view to covering an initial predefined geographical area, according to the following steps of:

Step 202: Defining an initial geographical area over which the wireless network must be deployed in such a way that the set of EMs that must be served by the wireless network is initially located in this geographical area. It is then assumed that the initial locations of each of the EMs are known.

Step 204: Partitioning the initial geographical area into multiple sub-areas, with each geographical sub-area having to be covered by a distinct VMSSF. The size of each sub-area can be defined based on the maximum radio range that can be reached by the wireless base station equipped with the VMSSF, taking into account the wireless propagation conditions specific to the targeted sub-area.

Step 206: Defining the location of each VMSSF responsible for a sub-area. Typically, this location can be defined, for example, as the central point of the sub-area, assuming that the VMSSF is equipped with a wireless base station providing omnidirectional coverage (being equipped with an omnidirectional transmitter/receiver, for example).

Step 208: Defining the parameters of the wireless cells offered by each VMSSF (for example the frequency band), notably with a view to avoiding or minimizing any interference with the VMSSFs of the neighboring sub-areas, for example, by allocating separate frequency bands to the VMSSFs covering neighboring sub-areas, but potentially slightly overlapping one another in order to ensure continuity in terms of the wireless coverage in the area.

Step 210: Deploying each VMSSF to its location thus defined. This step can be carried out according to the method described in the aforementioned patent application of the Applicant in order to maintain the connectivity of the VMSSF with the BA.

Step 212: Configuring the parameters, thus defined, of the wireless cells of each of the deployed VMSSFs and activating the wireless cell of each of said VMSSFs, so as to activate the coverage of the wireless network in the sub-area of each VMSSF.

Step 214: Continuously monitoring/surveilling (a) the tethering of the EMs to each of the different deployed VMSSFs, (b) the location of each of the EMs and (c) the overload risk notifications of the wireless cells of the VMSSFs.

The tethering of an EM to a VMSSF, i.e., to the wireless base station with which the VMSSF is equipped, can be easily detected by virtue of the nominal protocol/operation of the wireless technology used for the link between the EM and the VMSSF. The VMSSF can then easily feedback this tethering information to the system responsible for centralizing this information for all the EMs (and the various VMSSFs) and responsible for carrying out the present method.

An example of a procedure for tethering a mobile terminal to an access point of a wireless network is that of Wi-Fi networks. Wi-Fi standard IEEE 802.11 describes this tethering procedure for Wi-Fi, commonly called “association procedure”.

The methods described can be implemented on the back base or on a device located in the back network (for example a server).

Once connected to a VMSSF, each EM that can determine its location at any instant as it moves can feedback this location information to the system responsible for centralizing this information for all the EMs and responsible for carrying out the present method.

Each EM can be equipped with a location system allowing it to know its position in the environment in which it is moving at any instant. Any type of location system can be used, such as, for example, (i) satellite location systems (GPS, Galileo, Glonass), (ii) location systems via a radio infrastructure deployed on the ground, such as, for example, a UWB (“Ultra Wide Band”) location infrastructure, (iii) vision location systems using one or more cameras, notably via SLAM (“Simultaneous Localization And Mapping”) techniques, or even (iv) hybrid systems mixing several location techniques, such as satellite systems, via SLAM, or systems using other types of sensors (inertial units, compasses, accelerometers, odometers, etc.).

The surveillance/monitoring state 214 of the various parameters, (a) of tethering the EMs, (b) of locating the EMs, and (c) of overloading the wireless cells of the VMSSFs, allows automatic redeployment of the wireless network according to the redeployment method of the invention when this is detected as being necessary.

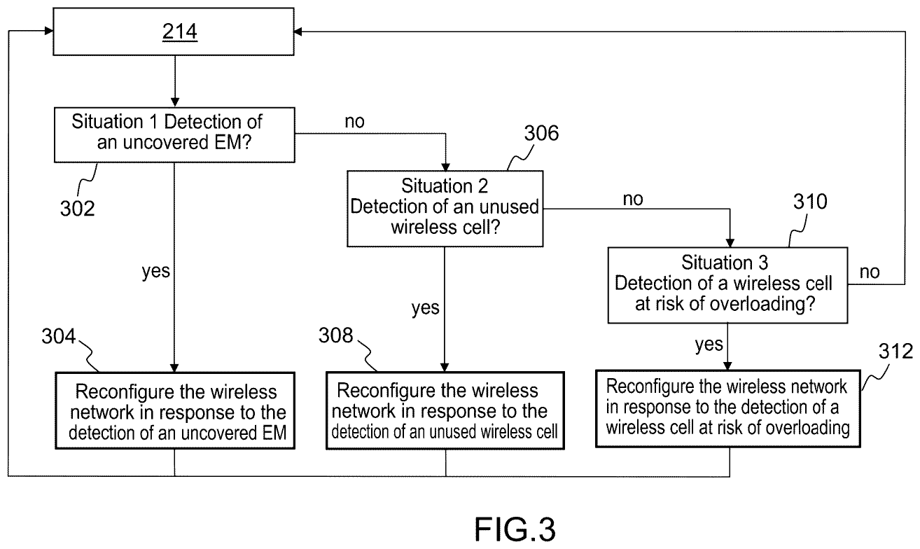

The automatic redeployment of the wireless communication network can be triggered as a function of various situations that can be detected, and that are described with reference to FIGS. 3 to 6.

FIG. 3 is a flowchart of the steps that allow, based on the continuous monitoring 214 of the aforementioned parameters (a), (b), (c), the detection of various situations for triggering the automatic redeployment of the wireless network within the context of the invention.

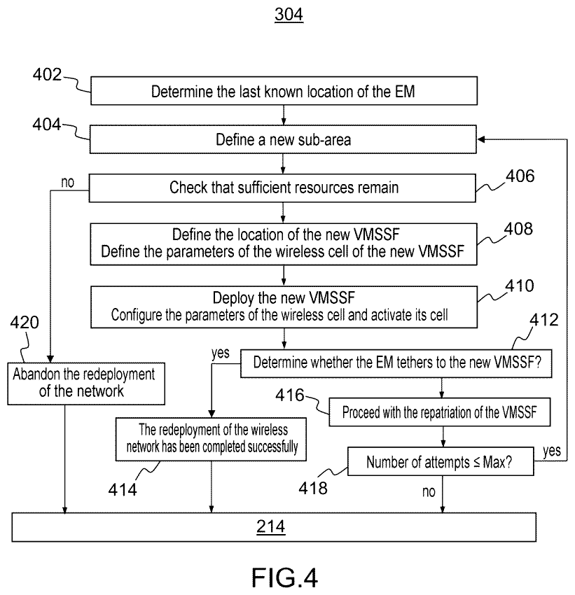

A first situation related to monitoring the parameter (a) for tethering EMs involves determining 302 when an EM is no longer covered by any VMSSF currently deployed in the overall coverage area of the wireless network. When this situation is identified, the method allows automatic reconfiguration of the wireless network 304 to be launched. The monitoring of the parameter (b) for locating EMs is used to determine the location of the new VMSSF to be deployed in the vicinity of the location where the EM, which is now disconnected, left the area covered by the wireless network. The reconfiguration of the network is described in detail with reference to FIG. 4.

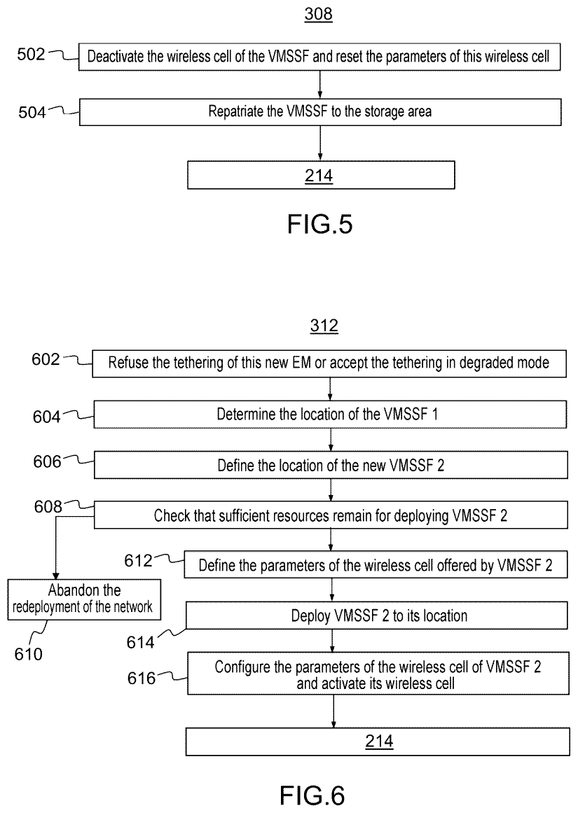

A second situation is linked to monitoring the parameter (a) for tethering EMs, and involves determining 306 whether a VMSSF is unused, i.e., if the wireless cell of a VMSSF is unused. When this situation is identified (detection that a VMSSF is unused from the moment no EM is tethered to its radio cell), the method allows automatic reconfiguration of the wireless network 308 to be launched. The reconfiguration of the network is described in detail with reference to FIG. 5.

A third situation relates to monitoring the parameter (c) of the risk of overloading the wireless cells of the VMSSFs, and involves determining 310 whether the wireless cell of a VMSSF is at risk of overloading. When this situation is identified, the method allows automatic reconfiguration of the wireless network 312 to be launched. The reconfiguration of the network is described in detail with reference to FIG. 6.

FIG. 4 is a flowchart of the steps carried out to trigger the automatic redeployment of the wireless network in the event that it has been determined that an EM no longer has network coverage from any of the VMSSFs that are currently deployed, and is therefore outside the overall area covered by the wireless network provided by the set of deployed VMSSFs. The method then allows the deployment to be organized for a VMSSF supporting the EM identified as no longer having network coverage.

After an EM moves relative to its initial location (i.e., the position during the initial deployment of the wireless network), the EM can be led out of the sub-area covered by the VMSSF it was initially tethered to. It can then enter a neighboring sub-area and tether to the new VMSSF serving this sub-area, and thus maintain its connectivity. In this case, the initial VMSSF notifies the central system responsible for carrying out the method of the untethering of the EM (once it is outside coverage) and the new VMSSF in turn notifies the central system of the tethering of this EM to this new VMSSF, thus confirming with the central system that the EM is still tethered to the wireless network.

As it moves the EM can also completely leave the overall area covered by the set of VMSSFs deployed over the initial geographical area and it can thus lose connectivity with the wireless network. In this case, without a notification indicating tethering to a new VMSSF, the central system can detect that the EM is no longer covered and that a redeployment of the wireless network is necessary in order to allow the EM to be covered again.

The central system then proceeds according to the following steps in order to ensure this redeployment:

Step 402: Determining the last known location of the EM currently disconnected from the wireless network.

Step 404: Defining a new geographical sub-area (outside the overall geographical area currently covered by the wireless network) in the vicinity of the last known location of the EM.

Step 406: Checking that sufficient resources remain for serving this new sub-area, i.e., that at least one VMSSF is still available and undeployed (and, if applicable, that sufficient RCRAs remain for covering the distance between the BA and this new sub-area). If insufficient resources remain, then the method is stopped and the network is not redeployed 420.

If enough resources remain to proceed with the redeployment of the network by adding the new previously defined sub-area, then the method continues with the following steps of:

Step 408: Defining the location of the new VMSSF responsible for this new sub-area. Typically, this location can be defined as the central point of the sub-area, assuming that the VMSSF is equipped with a wireless base station providing omnidirectional coverage. The method then allows the parameters of the wireless cell offered by this new VMSSF (the frequency band, for example) to be defined, notably with a view to avoiding or minimizing any interference with the VMSSFs of the neighboring sub-areas.

Step 410: Deploying the new VMSSF to the location that has been defined for it (using, if necessary, the deployment method described in the aforementioned patent application of the Applicant, with a view to maintaining the connectivity of the VMSSF with the BA). The method also allows the defined parameters of the wireless cell of the new deployed VMSSF to be configured and its wireless cell to be activated, so as to activate the coverage of the wireless network in the sub-area of each VMSSF.

Step 412: Determining whether the EM (which was hitherto disconnected) tethers to the new VMSSF thus deployed.

Step 414: If the EM tethers to the new VMSSF, and thus rediscovers its connectivity, the central system is then notified by the new VMSSF that the EM is again tethered to the wireless network, and the central system can also once again obtain the location information of the EM. The deployment of the wireless network has been carried out successfully, thus allowing the EM to rediscover network coverage.

Step 416: If the EM does not tether (for example after a predefined time), then the central system can proceed with the repatriation of the VMSSF that had been deployed in the new sub-area.

Step 418: The method loops back to step 404 to define a new sub-area where the VMSSF redeploys, and attempts to tether the EM. If, after several unsuccessful attempts (configurable parameter), the EM still has not been rediscovered or has not been tethered, the search process is stopped and the network ultimately has not been redeployed.

It should be noted that the method described for managing the first situation also advantageously allows a situation to be addressed whereby a given VMSSF would become faulty or inoperative, such that it can no longer offer wireless network coverage (this is the case during the failure, destruction, etc., of the VMSSF). Indeed, in this case, the central system (by determining the failure of the VMSSF or the lack of renewal of the tethering of the EMs to the VMSSF), determines that the EMs that were previously covered by said VMSSF are now not covered, and it can then proceed with the redeployment of the wireless network in this area (thus allowing the faulty VMSSF to be replaced with a new VMSSF).

Within the general context of the first described situation, the extension of the wireless network to cover a new sub-area by deploying a VMSSF therein is only triggered as soon as the disconnection of an EM is detected by the central system. This can then result in a relatively long time period during which the EM remains without network coverage, which is precisely the time that the extension of coverage in the new sub-area is set up. In order to overcome this problem, and ideally avoid any disconnection of EMs, a variant, “Variant 1”, of this method allows the central system to anticipate a possible loss of coverage of an EM and to previously initiate the deployment of the extension of the coverage of the network (via the deployment of a VMSSF) in a new sub-area toward which the EM is actually moving.

In this variant, the central system still continuously monitors the tethering of the EMs to the various deployed VMSSFs, as well as the location of each EM, but in addition it also collects additional speed and orientation/direction information of each EM in real time. The central system integrates a trajectory prediction module for each EM, which allows (regular) prediction of the future trajectory of a given EM, taking into account its past trajectory, its speed, its orientation/direction, optionally as well as additional information relating to the terrain (such as, for example, the presence of a road on which the EM is moving). By virtue of this trajectory prediction, and knowing the current overall coverage area of the network, the central system can then determine (regularly) (1) the instant T when said EM risks leaving the coverage area and (2) the last predicted location L of the EM when it will lose/leave this network coverage (corresponding to the point of intersection between the predicted trajectory for the EM and the perimeter of the network coverage area). The central system can then monitor this time indication T, and decide to deploy (in an anticipated manner) an extension of the network coverage (via the deployment of a VMSSF) in a new sub-area located in the vicinity of the point L (exit point of the EM from the coverage area) as soon as T is less than a reference value Tref, which can correspond, for example, to the time required (estimated by the central system) to deploy the extension of the network coverage in the new defined sub-area. Thus, the network coverage extension can be set up before said EM loses the network coverage.

If, however, the central system no longer has sufficient resources (in terms of a VMSSF and possible RCRAs to be associated) in the storage area, the central system can then send a warning to said EM notifying it of the risk of it losing connectivity within a time delay T if it continues its trajectory beyond the location L, so as to encourage it to alter its trajectory, if possible.

Naturally, once the coverage extension has been deployed (via a new VMSSF), the central system continues to predict the future trajectory of said EM and, if the new extension area proves to be no longer appropriate or necessary (and no other EM is tethered to the VMSSF), the central system can proceed with the repatriation of the relevant VMSSF.

FIG. 5 is a flowchart of the steps carried out to trigger (308) the automatic redeployment of the wireless network in the event that it has been determined (306) that a wireless cell of a VMSFF is not used, and then to organize the repatriation of the VMSFF.

Following the movements of the EM, a VMSSF can find itself without any EM tethered thereto (in the case, for example, where all the EMs have migrated to other sub-areas). The central system can then decide (for example after a certain configurable time period) to proceed with the repatriation of the unused VMSSF in order to recover resources (the possibly associated VMSSF and the RCRAs) with a view to future redeployments over new sub-areas.

To ensure the repatriation of a VMSSF, after having detected 306 that an EM is no longer connected to the VMSSF, in one embodiment the method carries out the following steps of:

Step 502: Deactivating the wireless cell of the VMSSF, and resetting the parameters of this wireless cell.

Step 504: Repatriating the VMSSF by notifying it to automatically return to the storage area.

Assuming that the deployment of RCRAs would have been necessary in order to deploy the VMSSF to its previous location, then automatic repatriation of these RCRAs to the storage area can be set up by applying the fallback method defined in the aforementioned patent application of the Applicant.

FIG. 6 is a flowchart of the steps carried out to trigger the automatic redeployment of the wireless network in the event that it has been determined that a wireless cell of a VMSSF risks overloading, and to organize the deployment of an additional supporting VMSSF.

Following the movements of the EMs, a VMSSF then can be found in a situation where its wireless cell risks being overloaded because the number of EMs to be served exceeds the capacities of the cell, which then requires the deployment of an additional VMSSF nearby in order to provide additional resources in the sub-area.

The central system then proceeds according to the following steps to ensure this redeployment:

Step 602: After having detected that a VMSSF is at risk of overloading when a new EM attempts to tether itself thereto, while there is already a maximum number of connected EMs with respect to the configuration of the VMSSF for supporting a maximum number of connected EMs simultaneously, the VMSSF can then refuse to tether this new EM (to avoid disrupting the quality of the connectivity of the other EMs) and can notify the central system of the risk of overloading.

In an alternative embodiment, rather than refusing to tether the new EM, the VMSSF can accept the tethering of this new EM but only by allocating radio resources thereto insofar as this does not disrupt the communications of the other EMs in the sub-area (the new EM then has a degraded mode connection). The VMSSF can then notify the central system of the risk of overloading and the set-up of this degraded mode for said new EM. The central system can then send a warning message to the EM to (a) notify it of its degraded mode and (b) recommend a direction to be followed in order to join a nearby sub-area likely to offer a better connection (to a VMSSF that has not yet reached its maximum number of connected EMs).

Step 604: After having received an overload notification, the method allows the location of the VMSSF (denoted VMSSF 1) that issued the notification to be determined.

Step 606: The method allows the position of the new VMSSF (denoted VMSSF 2) to be defined that will have to be deployed in the vicinity of the VMSSF 1 with a view to increasing the network resources offered to the EMs present in the sub-area of the VMSSF 1 and which is currently at risk of overloading. The location of the VMSSF 2 can be defined, for example, in such a way that it is as close as possible to the VMSSF 1, while ensuring that any risk of collision between the two VMSSFs is avoided.

Step 608: The method can be used to check that sufficient resources remain for deploying the new VMSSF 2 to this new location, i.e., that at least one VMSSF remains available, not deployed, in the storage area, and, if applicable, that enough RCRAs remain for covering the distance between the BA and this new location. If insufficient resources remain, then the process is stopped 610 and the network is not redeployed.

In an alternative embodiment, assuming that the new EM that is the source of the risk of overloading has not yet been placed in degraded mode (the connection has been accepted but with a minimum service that does not disrupt the communications of the other EMs in the sub-area), the VMSSF can then activate the degraded mode for said new EM, while notifying the central system. The central system can then send a warning message to the EM to (a) notify it of its degraded mode and (b) recommend a direction to be followed with a view to joining a nearby sub-area likely to offer a better connection (toward a VMSSF that has not yet reached its maximum number of connected EMs).

If sufficient resources remain for deploying the new VMSSF 2 to the new location, the method continues with the following steps of:

Step 612: Defining the parameters of the wireless cell offered by the new VMSSF 2 (the frequency band, for example), notably with a view to avoiding or minimizing any interference with the VMSSF 1 and the VMSSFs of the neighboring sub-areas.

Step 614: Deploying the new VMSSF 2 to its defined location (using RCRAs if necessary with a view to maintaining the connectivity of the VMSSF 2 with the BA).

Step 616: Configuring the defined parameters of the wireless cell of the new deployed VMSSF 2 and activating its wireless cell, so as to activate the additional coverage of the wireless network offered by the new VMSSF 2 in the sub-area jointly served by the two VMSSFs (VMSSF 1, VMSSF 2). The EM that is the source of the risk of overloading is thus able to detect the additional wireless cell provided by the new VMSSF 2 and to tether thereto, so as to have a quality connection to the wireless network.

In an alternative embodiment, assuming that the new EM that is the source of the risk of overloading would have been previously placed in degraded mode with the VMSSF 1, the central system can notify said new EM, as soon as the new VMSSF 2 has been deployed, of the deployment of the new VMSSF 2 and instruct it to tether to its wireless cell so as to quickly recover a quality connection to the wireless network.

The general principle of the third situation is that determining a risk of overloading a wireless cell is based on exceeding a maximum number of EMs that can be simultaneously connected to the same wireless cell. This approach, although simple to implement and reasonably realistic, nevertheless can sometimes result in the transmission of an overloading warning not considered on the central system (and in the non-admission of the new EM, or in placing it in degraded mode). A further alternative embodiment involves more precisely taking into account the network resources actually available in this cell, allowing the new EM to be admitted into the cell without any risk of disrupting the quality of the communications of the other EMs tethered to said cell.

Thus, determining a risk of overloading a wireless cell of a VMSSF is based (1) on the requirements of the various EMs in terms of Quality of Service (QOS) and (2) on the set of wireless resources available on the cell (without taking into account a maximum number of EMs per cell). If the QoS requirements of a new EM entering a sub-area can be met by the wireless cell, this new EM can be admitted and tethered to the cell, and if this is not the case then it is not admitted (or admitted only in degraded mode with a reduced allocated QoS level and therefore a reduced service) and a warning of a risk of overloading is then transmitted to the central unit so that it can proceed with the deployment of an additional VMSSF in the sub-area.

In another alternative embodiment in the case of the third situation, the central system, knowing the location and the trajectory information of the EMs, can anticipate the upcoming movement of an EM between a first area covered by a first VMSSF and a second area covered by a second VMSSF. It can therefore determine, in an anticipated manner, whether or not this movement risks overloading the second VMSSF. If the risk of overloading is confirmed, then the central system can proceed, still in an anticipated manner, with the deployment of an additional VMSSF in the future destination area of the EM and thus make more resources available (in an anticipated manner) in this area so as to serve this additional EM as soon as it arrives without any overloading. The new EM is then taken over by the new VMSSF that has just been deployed.

According to one embodiment, in the event of insufficient resources in the storage area during the redeployment of the wireless network, the relative priority of the EMs is taken into account. In this variant of the method of the invention, various priorities can be allocated to the various EMs, with the priority corresponding to the level of criticality of the network connectivity from the point of view of the operational functioning of the EM (i.e., its ability to carry out its mission). Thus, assuming that (a) the central system no longer has sufficient resources (VMSSFs and RCRAs) available for deploying a new VMSSF with a view to preserving the connectivity of an EM1 with a high priority level that would leave the network coverage and that (b) there is another VMSSF serving a single EM2 with a priority level lower than EM1, then the central system can decide to proceed with the repatriation of the VMSSF serving EM2 (while notifying EM2 of its future loss of connectivity and by inviting it to move to a nearby sub-area), in order to recover sufficient resources for covering EM1. Prior to this repatriation, the central system will evaluate the resources (notably the number of RCRAs) available with this repatriation so as to ensure that they will be sufficient to redeploy the network to EM1. If this is not the case, then the central system will have to identify other potentially usable resources (for example another EM with a lower priority level and only served by another VMSSF) in order to be able to proceed with the redeployment.

A variant of the invention allows the relative priority of the EMs to be taken into account for managing tethering to the wireless cell of a VMSSF, and for implementing the degraded mode for an EM.

In this variant, where various priorities are allocated to the various EMs, the central system can then take into account these priorities in order to offer the network connectivity, giving priority to the EMs with the highest priority level compared to the others. Thus, if a high-priority EM enters the coverage of a wireless cell and the central system detects a risk of overloading, the central system can then grant network access to this new high-priority EM and reject (or switch to degraded mode) another EM of this same cell with a lower priority. This notably allows the connectivity of the high-priority EM to be maintained as well as possible, while also allowing the redeployment, if possible, of additional resources (a VMSSF and RCRAs) to this sub-area with a view to re-establishing a satisfactory level of connectivity for the lower priority EM that has just been rejected (or switched to degraded mode).

The various embodiments of the method for automatically redeploying the wireless network have been described for a back base that remains fixed over time. However, in some scenarios the average distance between the back base and the various mobile devices can increase significantly over time, which can then result in a definitive lack of resources (VMSFFs and/or RCRAs) for serving the mobile devices over a significant part of their mission.

In order to overcome this problem, two alternative embodiments of the method for automatically redeploying the wireless network according to the invention ensure the continuity of the wireless network connectivity for all the mobile devices, even when said devices move so far from the back base that it no longer has sufficient resources (VMSSFs and RCRAs) available to serve them.

In a first alternative embodiment, the method is based on a mobile back base (and its storage area), and allows the necessary resources to be minimized, yet with the disadvantage of introducing a temporary interruption of the network connectivity, namely the time to relocate the back base.

In a second alternative embodiment, the method is based on the joint use of two mobile back bases (and their storage area). This alternative embodiment requires more resources but offers the advantage of being able to avoid the temporary interruption of network coverage for the mobile devices.

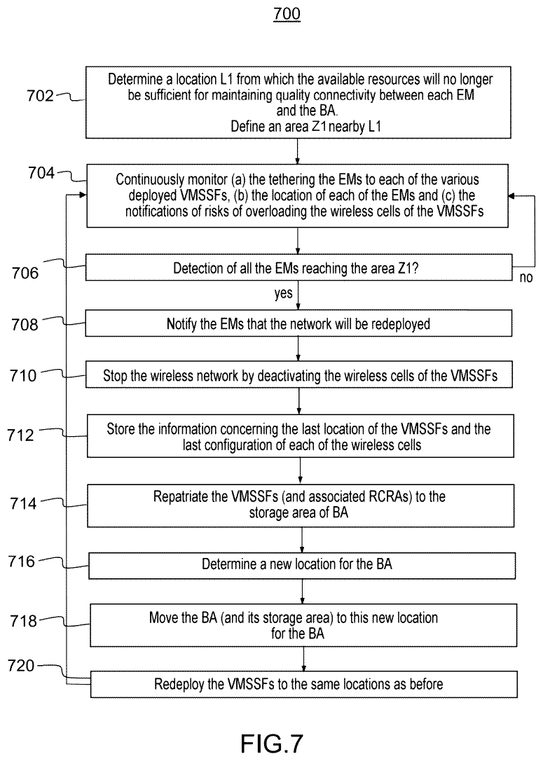

FIG. 7 is a flowchart of steps 700 carried out by the method of the invention in the embodiment with movement of a single back base.

In an initial step 702, while the wireless network is already deployed to serve the various EMs, the method can be used to determine that there will be a shortage of resources (VMSSFs and/or RCRAs) for serving the EMs. This determination can be made, for example, based on the knowledge (of the central system) of the mission of the EMs, for example, when the trajectory of the various EMs is known a priori, as in the case of a convoy of EMs having to move from an initial location to a final location.

Knowing this a priori trajectory and all the resources (VMSSFs and RCRAs) the BA has available, the central system is configured to determine at which point of the trajectory of the EMs (denoted location L1) it will reach a situation involving a shortage of resources for maintaining the quality connectivity between the EMs and the BA. Thus, when the central system determines that the EM approaches this location L1 (or that the convoy will reach it from now until a period T1), it can determine that it will soon lack resources and then proceed with the redeployment of the wireless network, as indicated in the following steps.

The central system is also configured to also define an area Z1 in the vicinity of L1, then decide to proceed with the redeployment of the wireless network (according to the following steps) as soon as the EMs have reached this area Z1.

According to this configuration, the steps for redeployment, while the central system continuously monitors 704 the various parameters (a) of tethering the EMs to each of the various deployed VMSSFs, (b) of locating each of the EMs and (c) of notifying of risks of overloading the wireless cells of the VMSSFs, involve:

Step 706: Determining when all the EMs have reached the area Z1 in the vicinity of the location L1 that has been determined.

Step 708: Notifying all the EMs that the network will be redeployed and that this redeployment will involve a temporary loss of the network coverage. Optionally, the central system can indicate the duration of this interruption (with this duration corresponding to the time for finalizing the redeployment of the wireless network).

Step 710: Stopping the wireless network, by deactivating the wireless cells of the VMSSF.

Step 712: Storing the information concerning the last location of the VMSSFs and the last configuration of each of the wireless cells (for example their frequency band) in a memory.

Step 714: Repatriating all the VMSSFs (and associated RCRAs) to the storage area.

Step 716: Determining whether a new location closer to the previously determined location L1 exists for the BA (corresponding to a destination for significantly reducing the average distance between the EMs and the BA).

Step 718: Moving the BA (and its storage area) to the new location. The BA can be moved automatically, for example, remotely-controlled by the central system.

Step 720: Once the BA has reached its new location, the method can be used to proceed with the redeployment of the network to the same location and in the same configuration (stored in a memory by the central system) as that set up prior to the temporary deactivation of the wireless network. The central system thus redeploys the VMSSFs to the same locations as above and resets the configurations of the various radio cells of these VMSSFs.

The EMs that are covered then rediscover the availability of the wireless network and tether to it.

If some of the situations 1, 2 or 3 as described previously appear when the BA is now in its new location, the central system then proceeds with the redeployment of the network according to the corresponding base method (304, 308, 310).

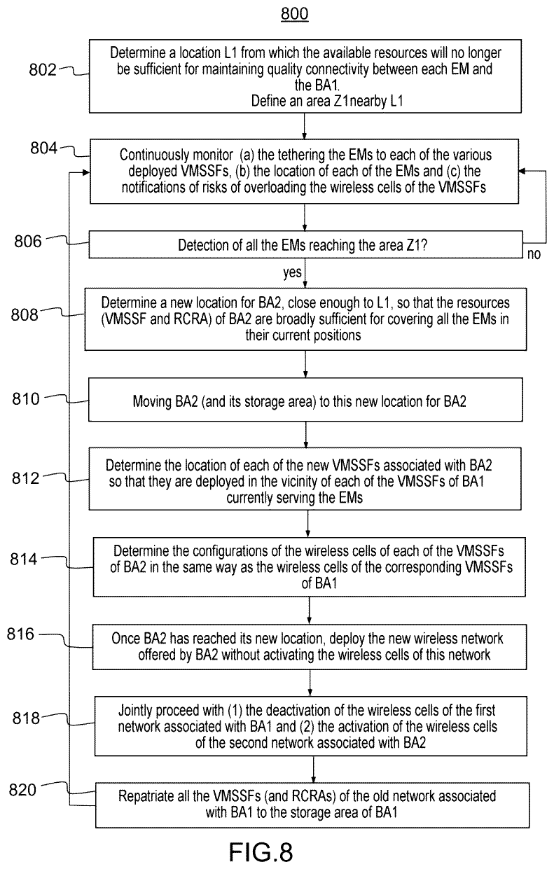

FIG. 8 is a flowchart of the steps carried out by the method of the invention in the embodiment with movement of two back bases.

This method is an alternative to that of FIG. 7 and offers the advantage of being able to avoid the temporary interruption of network coverage for the EMs while the BA reaches its new location. To this end, it relies on the joint use of two mobile BAs (BA1 and BA2), each associated with its storage area, which is also mobile.

In an initial step 802, while the wireless network is already deployed to serve the various EMs, by relying on a first back base BA, called first back base BA1, the method is used to determine that there will be a shortage of resources (VMSFFs and/or RCRAs) for serving the EMs. This determination can be made, for example, based on the knowledge (of the central system) of the mission of the EMs, for example, when the trajectory of the various EMs is known a priori, such as in the case of a convoy of EMs that have to move from an initial location to a final location.

Knowing this a priori trajectory and all the resources (VMSSFs and RCRAs) the BA has available, the central system is configured to determine at which point of the trajectory of the EMs (denoted location L1) it will reach a situation involving a shortage of resources for maintaining the quality connectivity between the EMs and the BA. Thus, when the central system determines that the EMs approach this location L1 (or that the convoy will reach it from now until a period T1), it can determine that it will soon lack resources and then proceed with the redeployment of the wireless network, as indicated in the following steps. The parameter T1 can be selected so that the delay T1 is slightly greater than the time required to deploy the second BA (denoted BA2) to its new location.

The central system is also configured to also define an area Z1 in the vicinity of L1, then decide to proceed with the redeployment of the wireless network (according to the following steps) as soon as the EMs have reached this area Z1 (for example, Z1 is selected such that, when the EMs are all in the area Z1, then they are likely to reach the point L1 within a delay that is slightly greater than T1).

According to this configuration, the steps for redeployment, while the central system continuously monitors 804 the various parameters (a) of tethering the EMs to each of the various deployed VMSSFs, (b) of locating each of the EMs and (c) of notifying of risks of overloading the wireless cells of the VMSSFs, involve:

Step 806: Determining when all the EMs have reached the area Z1 in the vicinity of the location L1 that has been determined.

Step 808: Determining a new location for the second back base BA2, close enough to L1, so that the resources (VMSSFs and RCRAs) of this back base BA2 are broadly sufficient for covering all the EMs in their respective current positions. For example, assuming that BA1 and BA2 have the same amount of resources, the central system can determine this new location of BA2 so that it is closer than that of BA1 with respect to the previously determined location L1 (i.e., a destination for reducing the average distance between the EMs and BA2, compared with that between the EMs and BA1).

Step 810: Moving the second back base BA2 (and its storage area) to this new location for BA2. Within this context, BA2 can be moved automatically, for example, remotely-controlled by the central system.

Step 812: Determining the location of each of the new VMSSFs (associated with BA2) that will have to be deployed in the vicinity of each of the VMSSFs of BA1 currently serving the EMs. To this end, the central system can define, for example, the location of a wireless base station VMSSF 2 (associated with BA2) such that the VMSSF 2 is as close as possible to the VMSSF 1 (associated with BA1), while ensuring that any risk of collision is avoided between the two VMSSFs.

Step 814: Determining the configurations of the wireless cells of each of the VMSSFs of BA2 in the same way as the wireless cells of the corresponding VMSSFs of BA1: thus, the VMSSF 2 (associated with BA2) covering the same sub-area as the VMSSF 1 (associated with BA1) will have the same wireless cell configuration.

Step 816: Once BA2 has reached its new location, deploying the new wireless network offered by BA2 (i.e., deploying the corresponding VMSSFs) without yet activating the wireless cells of this network (i.e., without activating the radio coverage).

Step 818: Once the VMSSFs of the new wireless network associated with BA2 have been set up, the wireless cells of the first network associated with BA1 are deactivated and the wireless cells of the second network associated with BA2 are activated. In order to accelerate the tethering of the EMs to the new network (associated with BA2) that has just been activated, the central system, via the VMSSFs of BA2, can send a network tethering request to all the EMs. Alternatively, the central system can also collect and store the network context of the wireless cells of the old network (associated with BA1) in a memory before its deactivation and push this network context to the new wireless cells (associated with BA2) so as to allow automatic and transparent tethering of the EMs to the new network, without any particular action by the EMs.

Step 820: Repatriating all the VMSSFs (and RCRAs) of the old network associated with BA1 to the storage area of BA1.

Once the EMs served by the new network are associated with BA2, if some of the previously described situations 1, 2 or 3 occur while BA2 is now in its new location, the central system then redeploys the network according to the corresponding base method (304, 308, 310).

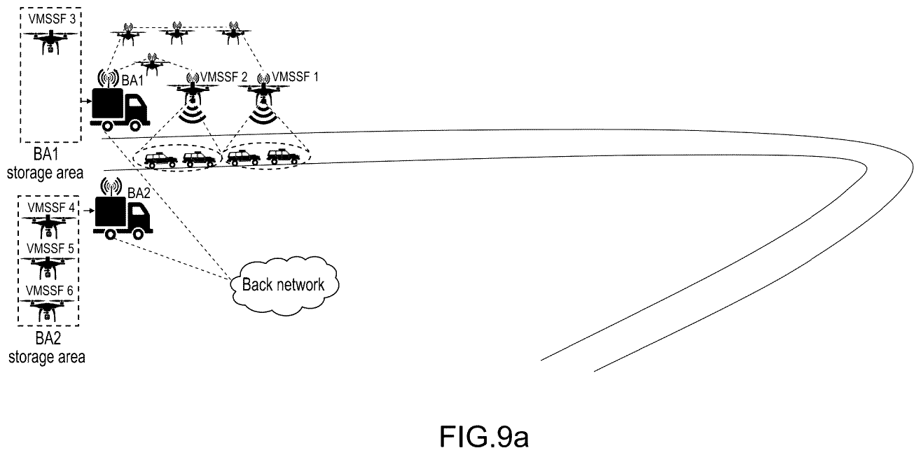

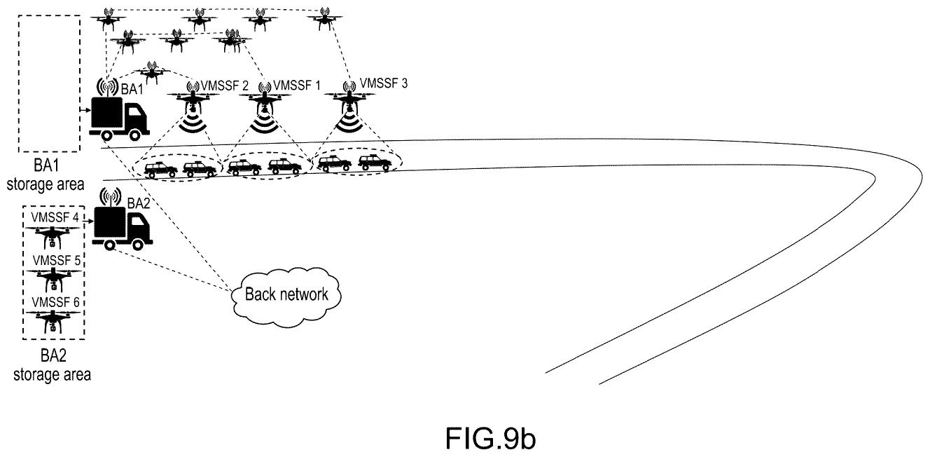

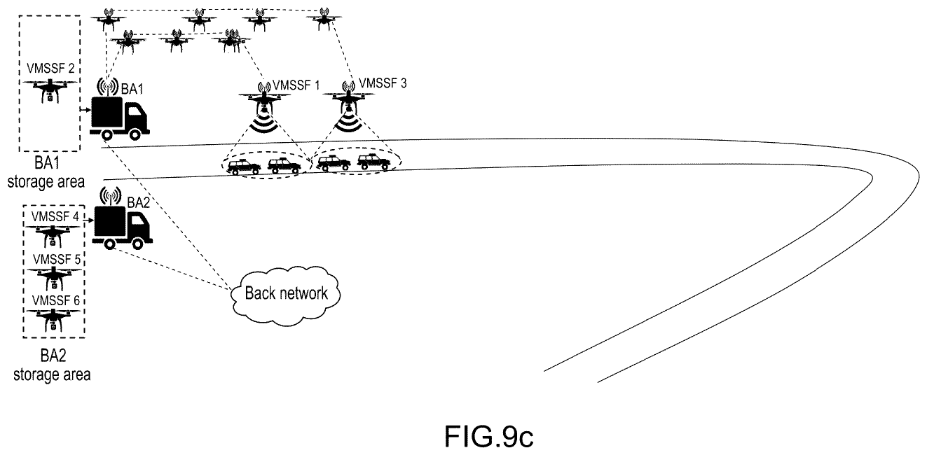

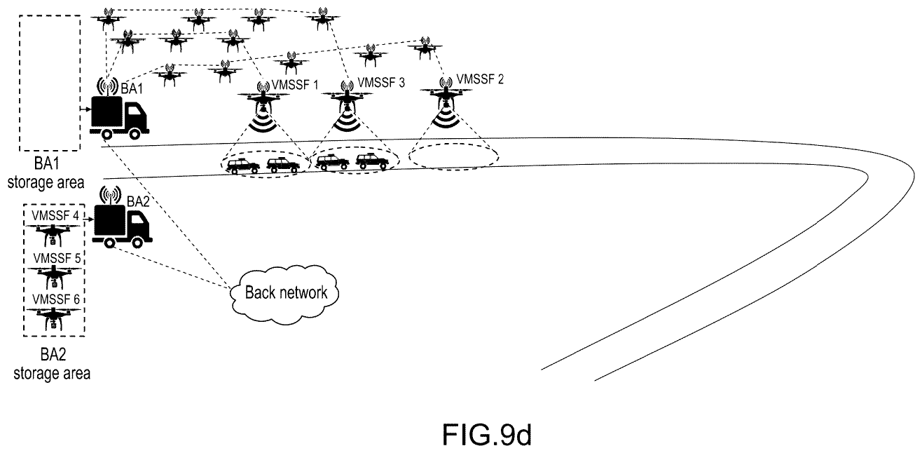

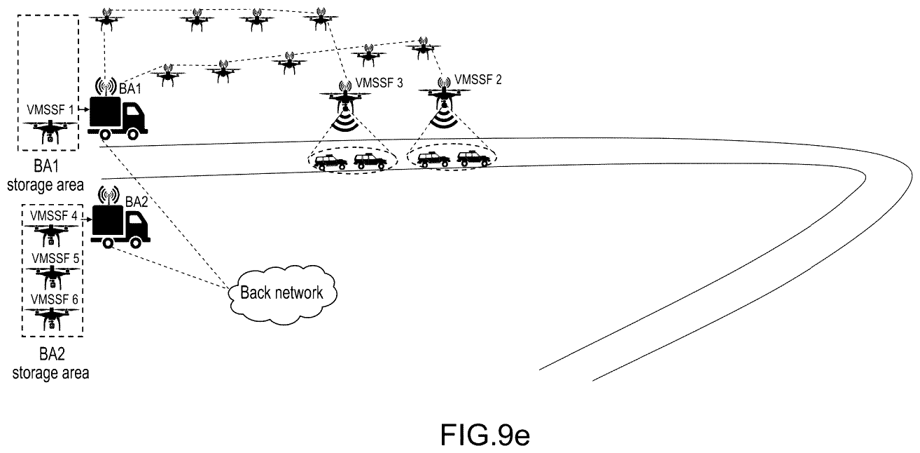

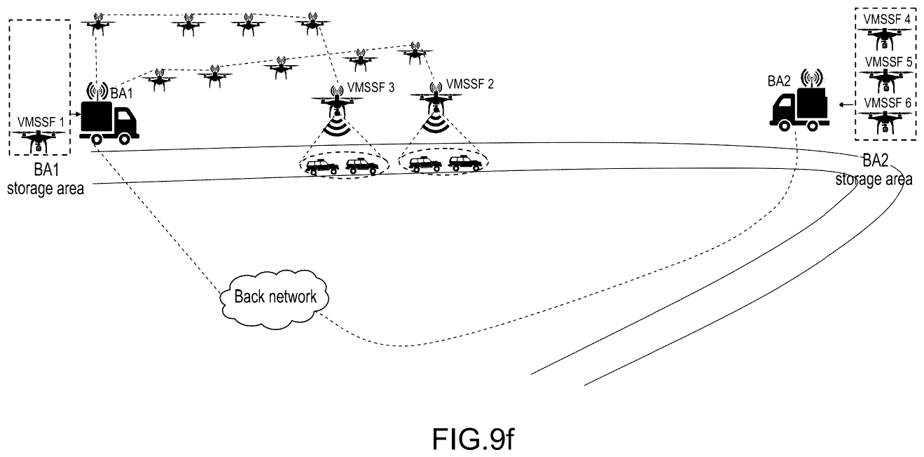

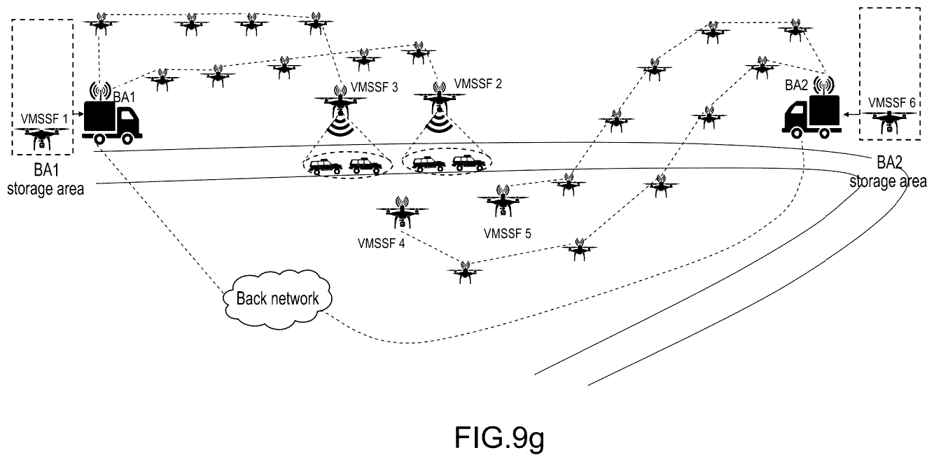

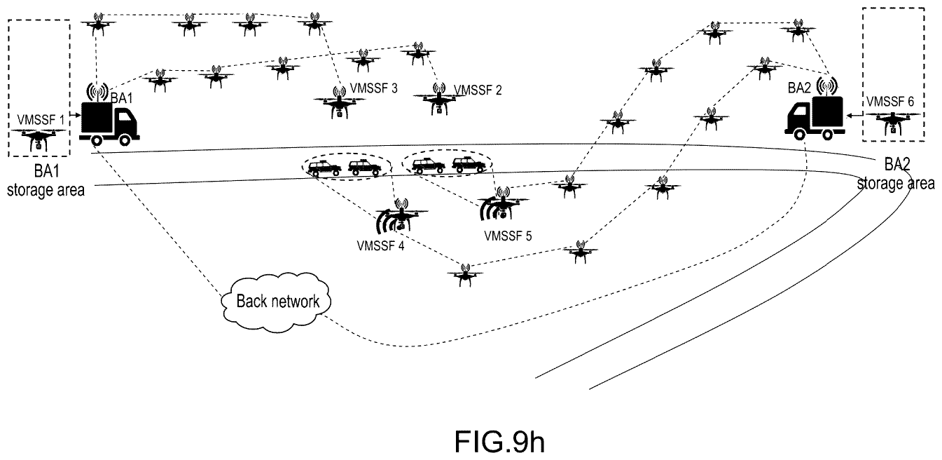

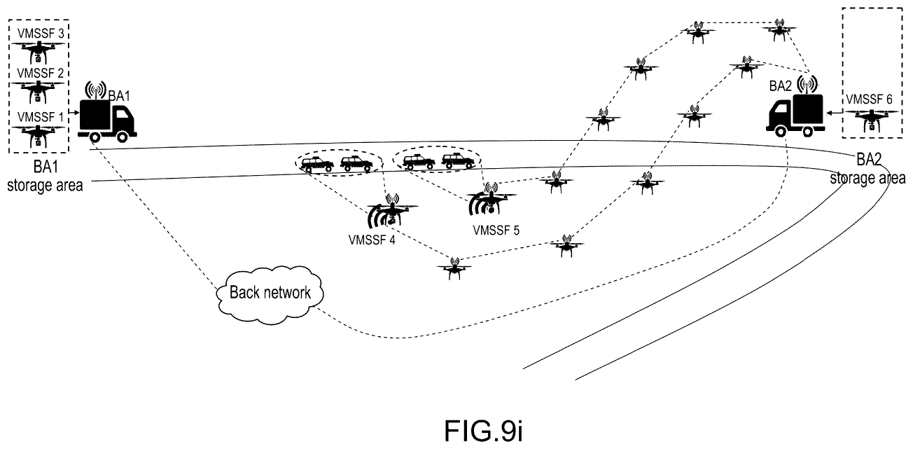

FIGS. 9a to 9i illustrate various embodiments of the method of the invention.

The examples are based on a scenario in which a convoy of 4 vehicles is traveling along a road, with the vehicles in this convoy having to be interconnected with one another as well as having to be connected to a back network by virtue of a wireless network that can be dynamically redeployed according to the methods of the present invention.

In this scenario, 2 back bases (BA1 and BA2) are available, both connected to the back network. Each of the BAs has 3 VMSSFs. BA1 also has 12 RCRAs; BA2 has slightly more RCRAs, for example 14 RCRAs.

In FIG. 9a, the convoy starts from its starting point; it is served by BA1 and a wireless network made up of 2 VMSSFs (VMSSF 1 and VMSSF 2) and 4 associated RCRAs, with this network having been set up according to the initial deployment method of the wireless network (FIG. 2).

In FIG. 9b, after the convoy moves, the wireless network has been reconfigured to add a third VMSSF (VMSSF 3) at the head of the convoy so as to provide the necessary wireless coverage in this previously uncovered area. The redeployment was carried out according to the method for automatically redeploying the wireless network in situation 1 (FIG. 3 (302, 304) and FIG. 4).

In FIG. 9c, the VMSSF 2 that was then no longer used was repatriated to the storage area of BA1 according to the method for automatically redeploying the wireless network in situation 2 (FIG. 3 (306, 308) and FIG. 5).

In FIG. 9d, the VMSSF 2 has been redeployed to the front of the convoy, in anticipation of the future arrival of the leading vehicles of the convoy in this area, according to the method for automatically redeploying the wireless network in situation (FIG. 3 (302, 304) and FIG. 4) with variant 1 (anticipate the loss of coverage of an EM).

In FIG. 9e, the convoy has progressed to the sub-area served by the VMSSF 2, where no vehicles were left in the sub-area of VMSSF 1; the latter was therefore repatriated to the storage area of BA1 according to the method for automatically redeploying the wireless network in situation 2 (FIG. 3 (306, 308) and FIG. 5).

In FIG. 9f, it has been detected that the convoy can then no longer be served by BA1 for the remainder of its journey, due to a lack of resources (in this case due to a lack of RCRAs), and BA2 is then redeployed to a new location so that it can take over from BA1, according to the method for automatically redeploying the wireless network with movement of the BA, based on the joint use of two mobile BAs (FIG. 8).

In FIG. 9g, according to this same method, the VMSSFs associated with BA2 are deployed in an area so as to cover the convoy.

In FIG. 9h, the wireless network associated with BA2 is activated at the same time as the network associated with BA1 is deactivated, thus allowing the vehicles of the convoy to retain the network connectivity, yet now via the new network offered by BA2.

In FIG. 9i, according to this same method, the wireless network associated with BA1 is dismantled and its VMSSFs (and RCRAs) are repatriated to the storage area of BA1.

In an advantageous embodiment, the invention is implemented via an oriented network management architecture (SDN, for “Software Defined Networking”). This architecture relies on an SDN controller set up on the central system (on a BA or a server connected to the back network) and able to control the configurations of a set of SDN devices (the one or more BAs, the RCRAs and the VMSSFs) via its “Southbound Interface”.

In this SDN implementation, the methods described above with reference to FIGS. 2 to 8 can be implemented in the form of an SDN service (on the central system) interfacing with the SDN controller via its Northbound Interface, so as to control the configurations of the various SDN devices that can be reached via the Southbound Interface of the SDN controller.

This SDN service is thus responsible for 1) managing the initial deployment of the wireless network and 2) detecting that a reconfiguration of the geographical deployment of the wireless network is necessary and then controlling this reconfiguration (by setting up reconfigurations on the one or more relevant BAs, RCRAs and VMSSFs), thus notably taking responsibility for controlling the geographical relocations of the VMSSFs (and RCRAs associated with them).

The various methods of the invention can be implemented (in the form of a computer/software program) on a central system. In the case where a single back base is used, the central system can be located on this back base or on a server connected to the back network (with the back base itself being connected to this back network). In the case where several mobile back bases are used, the central system also can be located on one of these mobile back bases or on a server connected to the back network.

Various embodiments of a method for automatically redeploying a wireless network according to the invention have thus been described, allowing various situations to be covered, notably including:
Situation 1: Detection of an uncovered mobile device, and deployment of a mobile vehicle equipped with a supporting wireless base station.
Situation 2: Detection of an unused wireless cell, and repatriation of the mobile vehicle equipped with a wireless base station.
Situation 3: Detection of a wireless cell at risk of overloading, and deployment of a mobile vehicle equipped with an additional supporting wireless base station.

And also allowing various variants to be covered, notably including:
Variant 1: Anticipating the loss of coverage of a mobile device.
Variant 2: Taking into account the requirements in terms of Quality of Service of the mobile devices when determining a risk of overloading a wireless cell of a mobile vehicle equipped with a wireless base station.
Variant 3: Taking into account the relative priority of the mobile devices in the redeployment of the wireless network in the event of insufficient resources in the storage area.
Variant 4: Taking into account the relative priority of the mobile devices for managing tethering to the wireless cell of a mobile vehicle equipped with a wireless base station, and for setting up the degraded mode for a mobile device.
Variant 5: Anticipating a risk of overloading a wireless cell of a mobile vehicle equipped with a wireless base station.

1. A method for automatically redeploying the geographical coverage of a wireless telecommunications network interconnecting a plurality of wireless mobile devices and a common back base, the method comprising the following steps of:
partitioning an initial geographical coverage area of a wireless telecommunications network into sub-areas;
assigning a mobile vehicle equipped with a wireless base station to each sub-area, with each mobile vehicle equipped with a wireless base station being connected to said back base via a wireless link, and being positioned in a geographical position offering wireless network coverage over said sub-area to a set of wireless mobile devices;
monitoring the tethering of each wireless mobile device to at least one wireless base station of the initial geographical coverage area;
determining whether a wireless mobile device is no longer tethered to any wireless base station of the initial geographical coverage area;
determining, if said wireless mobile device is no longer tethered to any wireless base station, a geographical position for a mobile vehicle equipped with a wireless base station as a function of the geographical position of said untethered wireless mobile device, with said geographical position allowing wireless network connectivity to be established between said untethered wireless mobile device and the back base; and
deploying a mobile vehicle equipped with a wireless base station to said geographical position, with said position defining a new geographical coverage sub-area corresponding to an extension of the initial geographical coverage area.

2. The method as claimed in claim 1, wherein the step of monitoring the tethering of each wireless mobile device comprises steps involving continuously monitoring parameters, namely: (a) the tethering of the wireless mobile devices of each set of mobile devices to the mobile vehicle equipped with a wireless base station of the sub-area to which the set is linked, (b) the location of each of the wireless mobile devices, and (c) the risk of overloading the wireless cells of the mobile vehicles equipped with a wireless base station.

3. The method as claimed in claim 2, wherein the step of monitoring the parameter (a) of tethering the wireless mobile devices involves: detecting when a wireless mobile device is no longer under the wireless network coverage of any mobile vehicle deployed in the other sub-areas of the initial geographical coverage area, and reconfiguring the wireless network.

4. The method as claimed in claim 3, wherein the step of reconfiguring the wireless network comprises the following steps of:
determining the last known location of the mobile device disconnected from the wireless network;
defining a new geographical sub-area in the vicinity of the last known location of said mobile device;
checking that at least one mobile vehicle equipped with a wireless base station is still available for serving said new sub-area;
deploying said at least one mobile vehicle equipped with an available wireless base station to said new sub-area.

5. The method as claimed in claim 1, wherein the step of monitoring the tethering of each wireless mobile device involves detecting when a mobile vehicle equipped with a wireless base station is unused, and reconfiguring the wireless network.

6. The method as claimed in claim 5, wherein the step of reconfiguring the wireless network comprises the following steps of:
determining that no more wireless mobile devices are connected to the mobile vehicle equipped with a wireless base station that is detected as being unused;
deactivating the wireless cell of said mobile vehicle equipped with a wireless base station and resetting the parameters of said wireless cell;
repatriating the mobile vehicle equipped with a wireless base station to a storage area.

7. The method as claimed in claim 2, wherein the step of monitoring the parameter (c) of the risk of overloading wireless cells involves determining the location of a mobile vehicle equipped with a wireless base station that has issued an overload risk notification, and reconfiguring the wireless network.

8. The method as claimed in claim 7, wherein the step of reconfiguring the wireless network comprises the following steps of:
defining a geographical position in the vicinity of the location of the mobile vehicle equipped with a wireless base station that has issued an overload risk notification in order to deploy a new mobile vehicle equipped with a wireless base station;
checking that at least one mobile vehicle equipped with a wireless base station is still available and undeployed;
defining the parameters of the wireless cell of said new mobile vehicle equipped with a wireless base station;
deploying said new mobile vehicle equipped with a wireless base station to the defined geographical position;
activating the additional coverage of the wireless network offered by said new mobile vehicle equipped with a deployed wireless base station.

9. The method as claimed in claim 1, comprising steps involving determining that a mobile vehicle equipped with a wireless base station is no longer useful in a given area and repatriating it to the back base.

10. The method as claimed in claim 1, comprising steps involving determining a new geographical position for the back base and moving said back base to the new geographical position.

11. The method as claimed in claim 1, comprising steps involving determining a geographical position for a second back base, moving said second back base to the geographical position, and deploying a new wireless network interconnecting the plurality of wireless mobile devices and said second back base.

12. A computer program product, said computer program comprising code instructions for carrying out the steps of the method as claimed in claim 1, when said program is executed on a computer.

13. A device for automatically redeploying the geographical coverage of a wireless telecommunications network interconnecting a plurality of wireless mobile devices and a common back base, the device comprising means for implementing the steps of the method as claimed in claim 1.

14. The device as claimed in claim 13, wherein the mobile vehicle equipped with a wireless base station is a land or air or amphibious or aquatic vehicle, with said vehicle being remote-controlled or self-controlled.

15. The device as claimed in claim 13, wherein the communications network is implemented according to an SDN “Software Defined Networking” oriented architecture comprising an SDN controller having a Northbound Interface and a Southbound Interface, set up in a central system, with the SDN controller being able to control the configurations of a set of SDN devices formed by the one or more back bases via its Southbound Interface, with the mobile vehicles being equipped with a wireless base station.
